(19) United States
(12) Patent Application Publication
(10) Pub. No.: US 2005/0216424 A1
(43) Pub. Date: Sep. 29, 2005

(54) Transaction system with special handling of micropayment transaction requests

(75) Inventors: Thomas R. Gandre, Longwood, FL (US); Daniel J. Ruppe, Longwood, FL (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Star Systems, Inc.

(21) Appl. No.: 10/807,431

(22) Filed: Mar. 23, 2004

(51) Int. Cl. G06F 17/60

(52) U.S. Cl. 705/75

(57) ABSTRACT

A debit-type merchant transaction is conducted and the merchant transactions are automatically routed to customer accounts for payment of the merchant transactions. A user presents a form of account identification to an electronic transaction device to initiate a transaction. The account identification includes a customer account number. Each customer account is associated with a respective card issuer. At least some of the card issuers have for selected customers a debit account and a stored value account associated with the same customer account number. To perform a transaction, a customer inputs a transaction amount. A table is provided that includes a plurality of merchant categories and transaction threshold amounts for each merchant category. The merchant category is obtained for each initiated transaction. The inputted transaction amount is compared to the transaction threshold associated with the merchant. The user is required to enter the secret code for the selected transaction if the inputted transaction amount exceeds the transaction threshold amount associated with the merchant. A routing engine is provided that has individually specified routing rules for each of a plurality of different card issuers. The rules define when a transaction should be routed to the debit account and when a transaction should be routed to the stored value account. The routing rules are applied to the transaction and the transaction is routed to either the debit account or the stored value account.

### BACKGROUND OF THE INVENTION

Contactless smart cards and associated payment systems are well-known. These cards typically include RFID components for contactless communication, a chip, and a magnetic stripe to allow the card to be used in a conventional card reader. The information communicated via the RFID components is typically similar or identical to the information in the magnetic stripe. VISA has deployed different types of contactless smart card throughout the world. MasterCard provides a contactless smart card called the PayPass® card. The payment systems that use contactless cards typically provide only one payment channel. In the MasterCard system, all payment requests are routed through a conventional debit or credit authorization/payment network. In other systems, such as one VISA card scheme, all payment requests are processed offline by the card which includes a “stored value” account balance. These offline cards are sometimes referred to as an “electronic wallet” (e-wallet) or “electronic purse” (e-purse).

The prior art also includes cards that are associated with a central/remote “stored value” account. These cards are typically not contactless. They are typically simple plastic cards with magnetic stripes, and are commonly sold as gift cards. The account is initially charged and can be replenished by the card holder or a third party. The card contains an account number which is used to access the central account when a purchase is requested. These cards also provide only one payment channel. That is, all payment requests are directed to the central account which stores the account balance.

### BRIEF SUMMARY OF THE INVENTION

In a first embodiment of the present invention, a scheme is provided to determine whether to require a user to enter a secret code into an electronic transaction device for completing selected merchant transactions. To implement the scheme, a user presents a form of account identification to an electronic transaction device to initiate a transaction and a transaction amount is inputted. A table is provided that includes a plurality of merchant categories and transaction threshold amounts for each merchant category. The merchant category is then obtained for each initiated transaction. The inputted transaction amount is compared to the transaction threshold associated with the merchant. The user is required to enter the secret code for the selected transaction if the inputted transaction amount exceeds the transaction threshold amount associated with the merchant.

In a second embodiment of the present invention, a routing engine is provided for use in automatically routing debit-type merchant transactions to customer accounts for payment of the merchant transactions. Each customer account is associated with a respective card issuer. At least some of the card issuers have for selected customers a debit account and a stored value account associated with the same customer account number. The routing engine comprises individually specified routing rules for each of a plurality of different card issuers. The rules define when a transaction should be routed to the debit account and when a transaction should be routed to the stored value account. One example of a debit account is a Demand Deposit Account (DDA)/Checking account. One example of a routing rule is that if the transaction amount is under a predetermined threshold set for a merchant category associated with the merchant conducting the transaction, and no secret code is requested, then the transaction is routed to the stored value account, otherwise the transaction is routed to the debit account.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. However, the invention is not limited to the precise arrangements and instrumentalities shown.

In the drawings:

FIG. 1 shows a schematic block diagram of system elements in accordance with one preferred embodiment of the present invention;

FIG. 2 shows sample routing rules for use in the present invention; and

FIG. 3 shows a flowchart of the system of FIG. 1.

### DETAILED DESCRIPTION OF THE INVENTION

Certain terminology is used herein for convenience only and is not to be taken as a limitation on the present invention. In the drawings, the same reference letters are employed for designating the same elements throughout the several figures.

### I. DEFINITIONS AND INDUSTRY TERMINOLOGY

The following definitions and explanation of industry terms are provided to promote understanding of the invention.

SIC Code (Standard Industrial Classification Code)—This is a four digit numerical code assigned by the U.S. government to business establishments to identify the primary business of the establishment. Each merchant has an SIC code (e.g., 5192 is for a merchant selling “Books, Periodicals, Newspapers”; 7521 is for “Automobile Parking”; 5713 is for “Floor Covering Stores”). The merchant acquirer knows the SIC code for the merchants that it processes transactions for.

Merchant Category Code (MCC)—A code assigned by a Merchant Acquirer to identify a merchant's type or mode of business and the merchandise sold. The MCC serves the same purpose as the SIC code.

BIN (Bank Identification Number)—The issuer assigned number to a grouping of credit or debit cards. Typically, the BIN number is the first six through ninth digits of a card number, but could use up to the first twelve digits. The BIN thus can be used to identify the card issuer. Presently, the BIN is used to determine where to route a transaction for transaction approval and any account crediting or debiting that must occur. The present process is very straightforward. For example, if the BIN is 425333, the card issuer is CHASE, and all such transactions are routed to a preset location designated by CHASE.

PIN-based debit network (also, referred to herein interchangeably as a “payment network”)—Examples of these networks include STAR/MAC and NYCE. The customer typically must enter a secret code, such as a personal identification number (PIN) for this payment channel. (Some transactions, such as bill payment transactions, can be made via the debit network without entering a PIN). These transactions are typically low risk transactions that are made over the Internet or via voice (audio) response units (VRU's). For example, some payment locations allow a GlobalCash debit card to be used to make utility payments without entering a PIN.)

Combination credit/debit terminals—It is known to designate a transaction as being either credit or debit. Typically, a customer makes this decision at the checkout station by selecting the appropriate button on merchant equipment. If “credit” is selected, no PIN is requested and the transaction is routed to a credit payment authorization and posting channel. If “debit” is selected, the user is prompted to enter a PIN, and the resultant transaction is routed through a debit network. The initial credit/debit decision is under control of the customer or may be dictated by store policy, or may be made automatically by the merchant equipment.

Terminal driving software—A system that functions with the credit/debit hardware terminal that enables the hardware terminal to perform many payment card transaction processes.

### II. DETAILED DISCLOSURE

One purpose of the present invention is to allow customers to use a contactless payment device (such as a contactless smart card) or a traditional magnetic stripe payment card to make micropayments at merchants, instead of using cash (i.e., coins and bills) while still providing the flexibility to use the payment device as a debit card for larger purchases.

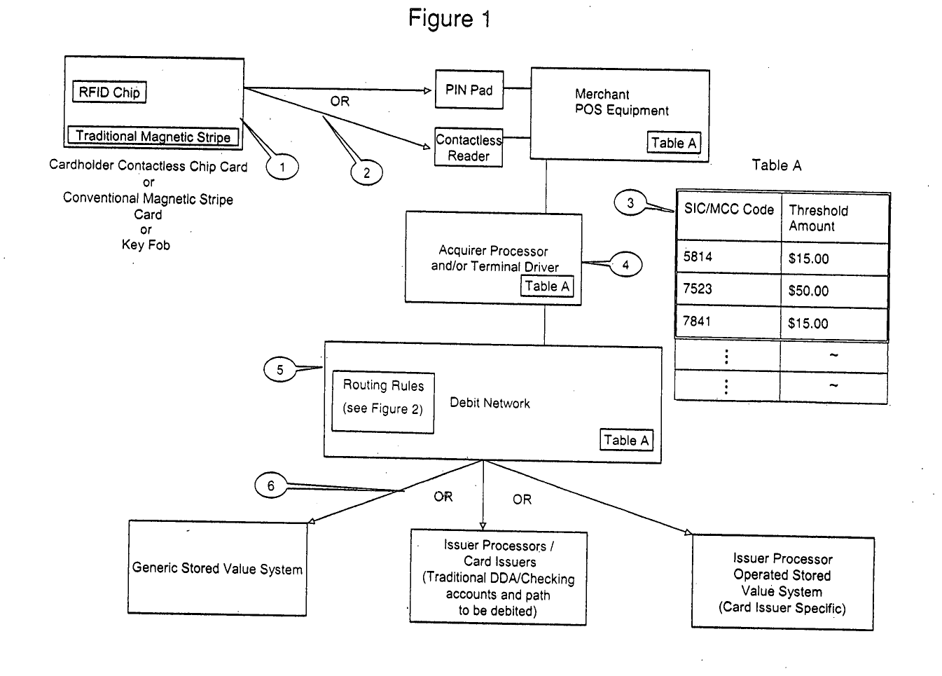

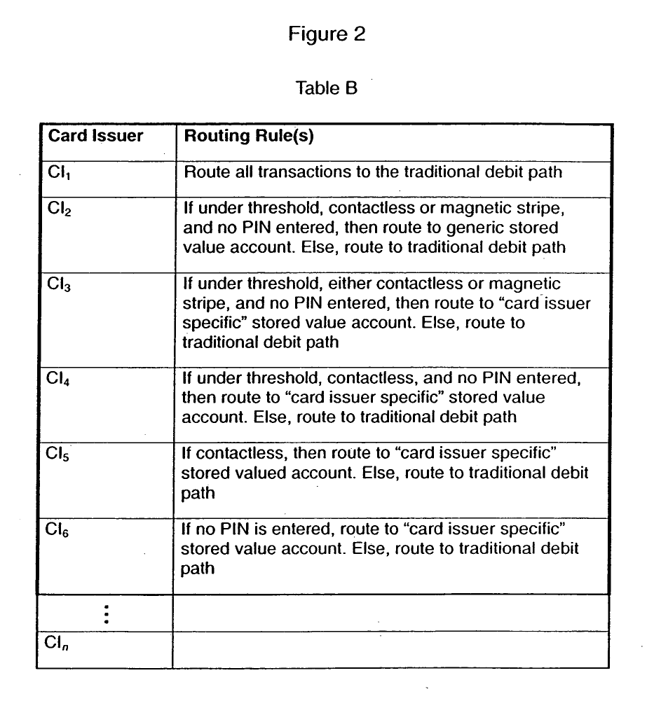

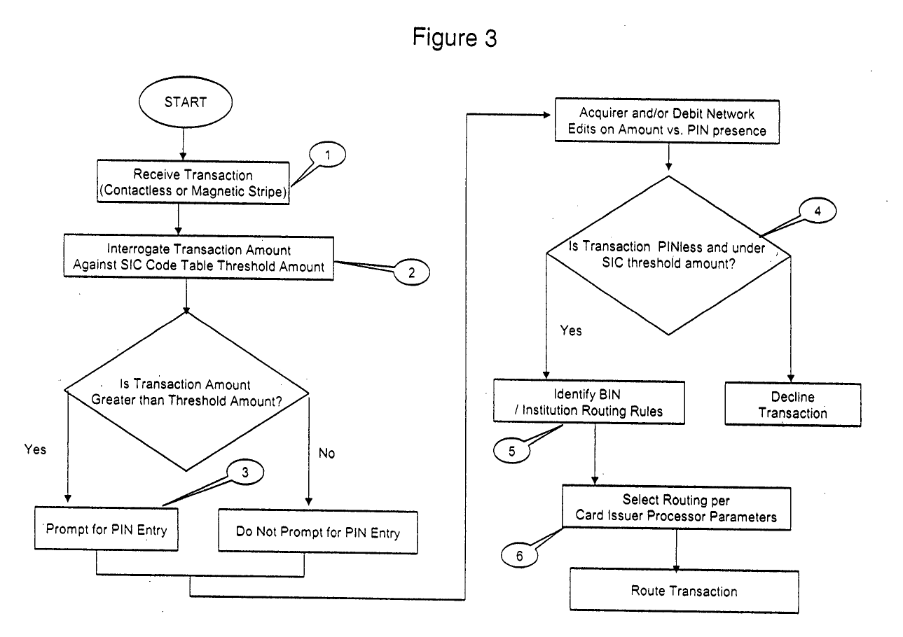

One preferred embodiment of the present invention is illustrated in FIGS. 1-3. FIG. 1 shows a schematic block diagram of system elements and includes Table A which provides specific threshold amounts for different SIC/MCC Codes. FIG. 2 shows Table B which provides one preferred embodiment of transaction routing rules. FIG. 3 shows one preferred embodiment of a flowchart for a process that uses the system of FIG. 1.

A contactless card or key fob with RFID capability, as described above, may be used with the present invention. Alternatively, a traditional magnetic stripe card may be used. Also, a central “stored value” account is provided, similar to those used in gift card programs.

Referring to FIG. 1 and FIG. 3, the process is implemented as follows:
1. A transaction is received at merchant POS equipment (FIG. 1, Step 1 and FIG. 3, Step 1).
2. The POS equipment can be a contactless chip card reader or a traditional magnetic stripe reader (FIG. 1, Step 2).
3. The merchant POS equipment or the terminal driving software identifies the SIC code or MCC for that merchant.
4. The merchant POS equipment or terminal driving software consults Table A (FIG. 1, Step 3) to determine if the transaction amount is greater than a threshold amount for the merchant type (FIG. 3, Step 2). If so, then the customer is prompted to enter a PIN (FIG. 3, Step 3). Otherwise, no PIN is requested or entered. Table A in FIG. 1 shows examples for three SIC codes or MCC's. This feature provides an added level of security because the thresholds for less secure PIN-less transactions may be adjusted based on typical payment amounts for the type of merchant.
5. The acquirer processor receives the transaction. If no SIC/MCC interrogation was executed on the transaction by the merchant POS and/or terminal driving software, the acquirer processor may execute an edit against the transaction to ensure that PINless transactions are below the SIC/MCC threshold amount using Table A in FIG. 1 (FIG. 1, Step 4 and FIG. 3, Step 4).
6. The payment network receives the transaction request, along with any PIN information, if entered, identifies the BIN, determines if the transaction is from a qualified micropayment merchant, and then consults Table B to automatically determine where to route the transaction. The payment network thus performs the function of a routine engine for implementing the routing rules in Table B. The payment network may also perform an edit to ensure that PINless micropayment transactions are under the SIC threshold (FIG. 1, Step 5 and FIG. 3, Step 4). At least the following three inputs are needed to implement the rules:
   i. the BIN (this is extracted from the card number and is used to identify the card issuer) (FIG. 3, Step 5);
   ii. whether the transaction was initiated at a micropayment qualified merchant, identified by SIC/MCC and/or other data elements within the transaction specific to a qualified micropayment merchant; and
   iii. whether a PIN was entered as part of the transaction (this data is also part of conventional transaction messages) (FIG. 3, Step 6).

If the debit route is identified, the BIN may be further used to route the transaction to the appropriate debit account for the card issuer, as is well-known in the prior art. Likewise, if the “stored value” account is identified, the BIN may be further used to route the transaction to the appropriate stored value account set up for that card issuer (FIG. 1, Step 6).

In one typical scenario, a contactless transaction request where no PIN was requested or entered (e.g., transactions below the threshold for the merchant type) will be routed to a “stored value” account if a card issuer has a “stored value” account or a relationship with a generic entity to manage their customer's “stored value” accounts. In this manner, a card issuer can have micropayments initiated via a customer's contactless component routed to “stored value” accounts, instead of flowing into the customer's debit account, such as a traditional Demand Deposit Account (DDA)/Checking account. See, for example, the transaction routing rules for card issuers CI₂ and CI₃ (FIG. 1, Step 6).

In another typical scenario, a transaction request where a PIN is requested and entered (e.g., transactions that are above the predetermined threshold for the merchant type) will be routed to the debit channel. See the “Else, route to debit” rule for card issuers CI₂ and CI₃ (FIG. 1, Step 6).

Some card issuers may have no stored value accounts set up and no arrangement with any other entity to provide for one, and thus all transactions are routed to their respective DDA/Checking accounts. See the routing rule for card issuer CI₁. Card issuers may select additional variations of routing rules based on transaction thresholds (either the same amount for all merchants, or merchant category-based thresholds that use Table A), whether the transaction is initiated with a contactless form of account identification, whether a PIN is entered, and the like.

In one embodiment, there is a single repository of central “stored value” accounts. In another embodiment, there are a plurality of repositories of central “stored value” accounts. For example, a large card issuer may wish to have its own repository for its customers.

The stored value accounts may be reloaded/replenished with funds from the customer's respective financial institution/card issuer accounts, either automatically upon dropping below a predetermined amount, or by a user requesting reloading/replenishment by logging onto a web site or by other means. Reloading/replenishment may occur by communication directly with the customer's respective financial institution/card issuer (not shown), or through the payment network (shown in FIG. 1).

In an alternative embodiment, a key fob or similar contactless device, such as a device similar to the ExxonMobil Speedpass®, is used instead of a contactless card.

Table A is an optional element of the POS equipment and the Acquirer Processor and/or Terminal Driver. If Table A is omitted from one or both of these elements, additional communications occur with the debit network to query Table A located therein when the check of the threshold amount is made.

While the merchant categories are preferably defined by SIC codes or MCC's which are already incorporated into existing merchant acquirer devices, other types of merchant category classifications may be used and are within the scope of the present invention.

The form of account identification is described above as being a physical contactless device or a card device (a magnetic stripe card or a smart card with or without a magnetic stripe card). However, the form of account identification may also be biometric data, such as a customer's fingerprint, retina scan, voice print, facial geometry, or the like. This type of account identification is a form of contactless non-physical account identification.

FIG. 2, Table B shows one routing rule for each card issuer. However, there may be multiple routing rules for each card issuer, as well as rules of priority if multiple rules conflict with each other.

The merchant POS equipment is shown in FIG. 1 as being the electronic transaction device for interfacing with the merchant and customer in performing a transaction. However, the merchant POS equipment may be any form of electronic transaction device and need not be physically located at a merchant. For example, a user may conduct a merchant transaction via the Internet using a web browser on a personal computer or handheld computer device, or via a voice (audio) response units (VRU's). If these alternative electronic transaction devices are used, the transactions may be treated as being contactless transactions for purposes of applying the routing rules. Alternatively, if specific transaction information is available that identifies these transactions as either being web-based or phone-based, then each issuer may define the routing rules for these types of transactions which may be the same or different than the routing rules for device-based contactless transactions (e.g., key fobs, contactless smart card) or magnetic stripe transactions.

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

1. A computer-implemented method of determining whether to require a user to enter a secret code into an electronic transaction device for completing selected merchant transactions, the method comprising:
(a) a user presenting a form of account identification to an electronic transaction device to initiate a transaction;
(b) inputting a transaction amount;
(c) providing a table that includes a plurality of merchant categories and transaction threshold amounts for each merchant category;
(d) obtaining the merchant category for each initiated transaction;
(e) comparing the inputted transaction amount to the transaction threshold associated with the merchant; and
(f) requiring the user to enter the secret code for the selected transaction if the inputted transaction amount exceeds the transaction threshold amount associated with the merchant.

2. The method of claim 1 wherein the selected transactions are transactions where the form of account identification is contactless.

3. The method of claim 2 further comprising:
(g) automatically routing the transaction to a user's stored value account for debiting of the transaction amount.

4. The method of claim 1 wherein the merchant transactions are debit transactions.

5. The method of claim 1 wherein the secret code is a PIN.

6. The method of claim 1 wherein the form of account identification is a physical contactless device.

7. The method of claim 1 wherein the form of account identification is a magnetic stripe card.

8. The method of claim 1 wherein the form of account identification is biometric data.

9. The method of claim 1 wherein the merchant categories are defined by SIC codes.

10. The method of claim 1 wherein the merchant categories are defined by merchant category codes.

11. A computer-implemented apparatus for determining whether to require a user to enter a secret code into an electronic transaction device for completing selected merchant transactions, the apparatus comprising:
(a) means for presenting a form of account identification to an electronic transaction device to initiate a transaction;
(b) means for inputting a transaction amount;
(c) a table that includes a plurality of merchant categories and transaction threshold amounts for each merchant category;
(d) means for obtaining the merchant category for each initiated transaction;
(e) means for comparing the inputted transaction amount to the transaction threshold associated with the merchant; and
(f) means for requiring the user to enter the secret code for the selected transaction if the inputted transaction amount exceeds the transaction threshold amount associated with the merchant.

12. The apparatus of claim 11 wherein the selected transactions are transactions where the form of account identification is contactless.

13. The apparatus of claim 12 further comprising:
(g) automatically routing the transaction to a user's stored value account for debiting of the transaction amount.

14. The apparatus of claim 11 wherein the merchant transactions are debit transactions.

15. The apparatus of claim 11 wherein the secret code is a PIN.

16. The apparatus of claim 11 wherein the form of account identification is a physical contactless device.

17. The apparatus of claim 11 wherein the form of account identification is a magnetic stripe card.

18. The apparatus of claim 11 wherein the form of account identification is biometric data.

19. The apparatus of claim 11 wherein the merchant categories are defined by SIC codes.

20. The apparatus of claim 11 wherein the merchant categories are defined by merchant category codes.

21. A routing engine for use in automatically routing debit-type merchant transactions to customer accounts for payment of the merchant transactions, each customer account being associated with a respective card issuer, at least some of the card issuers having for selected customers a debit account and a stored value account associated with the same customer account number, the routing engine comprising individually specified routing rules for each of a plurality of different card issuers, the rules defining when a transaction should be routed to the debit account and when a transaction should be routed to the stored value account.

22. The routing engine of claim 20 wherein the debit account is a Demand Deposit Account (DDA)/Checking account.

23. The routing engine of claim 20 wherein one of the routing rules is that if the transaction is detected as being initiated with a contactless form of account identification, then the transaction is routed to the stored value account, otherwise the transaction is routed to the debit account.

24. The routing engine of claim 20 wherein one of the routing rules is that if the transaction amount is under a predetermined threshold and no secret code is requested, then the transaction is routed to the stored value account, otherwise the transaction is routed to the debit account.

25. The routing engine of claim 20 wherein one of the routing rules is that if the transaction is detected as being initiated with a contactless form of account identification, the transaction amount is under a predetermined threshold set for a merchant category associated with the merchant conducting the transaction, and no secret code is requested, then the transaction is routed to the stored value account, otherwise the transaction is routed to the debit account.

26. The routing engine of claim 20 wherein one of the routing rules is that if the transaction amount is under a predetermined threshold set for a merchant category associated with the merchant conducting the transaction, and no secret code is requested, then the transaction is routed to the stored value account, otherwise the transaction is routed to the debit account.

27. The routing engine of claim 20 wherein one of the routing rules is that if no secret code is requested, then the transaction is routed to the stored value account, otherwise the transaction is routed to the debit account.

28. A computer-implemented method of conducting a debit-type merchant transaction and automatically routing the merchant transactions to customer accounts for payment of the merchant transactions, the method comprising:
(a) a user presenting a form of account identification to an electronic transaction device to initiate a transaction, the account identification including a customer account number, each customer account being associated with a respective card issuer, at least some of the card issuers having for selected customers a debit account and a stored value account associated with the same customer account number,
(b) inputting a transaction amount;
(c) providing a table that includes a plurality of merchant categories and transaction threshold amounts for each merchant category;
(d) obtaining the merchant category for each initiated transaction;
(e) comparing the inputted transaction amount to the transaction threshold associated with the merchant;
(f) requiring the user to enter the secret code for the selected transaction if the inputted transaction amount exceeds the transaction threshold amount associated with the merchant;
(g) providing a routing engine having individually specified routing rules for each of a plurality of different card issuers, the rules defining when a transaction should be routed to the debit account and when a transaction should be routed to the stored value account; and
(h) applying the routing rules to the transaction and routing the transaction to either the debit account or the stored value account.

29. The method of claim 38 wherein the selected transactions are transactions where the form of account identification is contactless.

30. The method of claim 29 further comprising:
(g) automatically routing the transaction to a user's stored value account for debiting of the transaction amount.

31. The method of claim 28 wherein the merchant transactions are debit transactions.

32. The method of claim 28 wherein the secret code is a PIN.

33. The method of claim 28 wherein the form of account identification is a physical contactless device.

34. The method of claim 28 wherein the form of account identification is a magnetic stripe card.

35. The method of claim 28 wherein the form of account identification is biometric data.

36. The method of claim 28 wherein the merchant categories are defined by SIC codes.

37. The method of claim 28 wherein the merchant categories are defined by merchant category codes.

38. The method of claim 28 wherein the debit account is a Demand Deposit Account (DDA)/Checking account.

39. The method of claim 28 wherein one of the routing rules is that if the transaction is detected as being initiated with a contactless form of account identification, then the transaction is routed to the stored value account, otherwise the transaction is routed to the debit account.

40. The method of claim 28 wherein one of the routing rules is that if the transaction amount is under a predetermined threshold and no secret code is requested, then the transaction is routed to the stored value account, otherwise the transaction is routed to the debit account.

41. The method of claim 28 wherein one of the routing rules is that if the transaction is detected as being initiated with a contactless form of account identification, the transaction amount is under a predetermined threshold set for a merchant category associated with the merchant conducting the transaction, and no secret code is requested, then the transaction is routed to the stored value account, otherwise the transaction is routed to the debit account.

42. The method of claim 28 wherein one of the routing rules is that if the transaction amount is under a predetermined threshold set for a merchant category associated with the merchant conducting the transaction, and no secret code is requested, then the transaction is routed to the stored value account, otherwise the transaction is routed to the debit account.

43. The method of claim 28 wherein one of the routing rules is that if no secret code is requested, then the transaction is routed to the stored value account, otherwise the transaction is routed to the debit account.
